(19) United States
(12) Patent Application Publication
(10) Pub. No.: US 2004/0069606 A1
(43) Pub. Date: Apr. 15, 2004

(54) ELECTRICAL SWITCH

(76) Inventor: King-Long Lee, Hsin-Tien City (TW)

Correspondence Address: BIRCH STEWART KOLASCH & BIRCH, PO BOX 747, FALLS CHURCH, VA, 22040-0747, US

(21) Appl. No.: 10/085,405

(22) Filed: Mar. 1, 2002

(51) Int. Cl. H01H 5/00

(52) U.S. Cl. 200/402

(57) ABSTRACT

An electrical switch comprises an assembly of a base and an upper cover. A conductor resilient plate is mounted in the switch with a resilient tongue that extends and bends toward the upper cover and is placed parallel with a push button on a same side of the conductor resilient plate. Thereby, the thickness of the upper cover and the base can be reduced, so the switch could be accommodated dimensionally electrical equipment.

### FIELD OF THE INVENTION

The invention relates to an electrical switch. More particularly, the invention provides an electrical switch having a height that is at least half reduced in comparison with that the prior art.

### BACKGROUND OF THE INVENTION

FIG. 1 is a sectional view illustrating a micro switch of the prior art, usually used in command output of mouse, keyboard, or power supply switch of electrical devices. As illustrated, the traditional micro switch principally comprises an assembly of a base 2b and an upper cover 1b. First and second insertion legs 3b, 4b are arranged through the base 2b. First and second positioning portions 31b, 32b are formed on the first insertion leg 3b. A hole 11b is defined through the upper cover 1b. A conductor resilient plate 5b is further mounted over the first and second insertion legs 3b, 4b. The plate 5b includes a first portion having a mounting part 51b mounted to the first positioning portion 31b, and a second portion provided with a contact pad 52b that is placed vis-a-vis the second insertion leg 4b. A resilient tongue 53b, integrally formed with the plate 5b, further extends and bends toward the base 2b, the tongue 53b having an end portion fastened to the second positioning portion 32b. A push button 6b is mounted over the plate 5b and is exposed through the hole 11b. When the user presses the push button 6b, the push button 6b consequently presses the plate 5b. With the mounting part 51b of the plate 5b electrically connected to the first insertion leg 3b, a pressing on the push button 6b thus causes an electrical contact of the contact pad 52b with the second insertion leg 4b by deflection of the plate 5b. An electrical switch having small contact deflection is hence traditionally constructed.

As illustrated in the drawings, mounting spaces have to be necessary left to allow pushing of the push button 6b and bending of the resilient tongue 53b. As a result, the height of the traditional switch (without the insertion legs 3b, 4b) is usually 7.3 mm. As electrical equipment become increasingly smaller, a traditional approach to accommodate the above electrical switch is to reduce the thickness of the upper cover 1b and the thickness of the base 2b. However, this approach negatively results in weakening the electrical switch, and causes cracks in the upper cover 1b or base 2b during product transportation or when the user pushes on the electrical switch. As the thickness of the base 2b or/and upper cover 1b is reduced, the switch further is more subject to deformation during injection molding or assembly in its fabrication process. As a result, the yield is negatively reduced.

Moreover, the above switch suffers another disadvantage. Because the resilient tongue 53b is positioned on the second positioning portion 32b by fitting, if only the plate 5b presents a defective deviation due to various fabrication deviations, the tongue 53b easily separates from the second positioning portion 32b after a certain time of utilization. Moreover, because the tongue 53b is proximate to the second insertion leg 4b, the tongue 53b when separated thus easily contacts with the second insertion leg 4b, thereby establishing an undesirable electrical contact.

### SUMMARY OF THE INVENTION

It is therefore an object of the invention to provide an electrical switch that can overcome the above deficiencies and has a height that is dimensionally reduced a half.

To accomplish the above and other objectives, the electrical switch of the invention comprises a conductor resilient plate having a resilient tongue that extends and bends toward the upper cover and is placed parallel with the push button on a same side of the conductor resilient plate. Thereby, traditional mounting spaces are not required. Furthermore, even if the resilient tongue inadvertently separates from the second positioning portion, the resilient tongue would upwardly deviate and therefore would not causes an electrical contact with the second insertion leg. A secure control of the command output is thereby achieved.

In accordance with another aspect of the invention, the base of the electrical switch further includes a reinforcement integrally formed with the base by injection molding. By means of the reinforcement, the thickness of the base and/or the upper cover can be reduced without adversely weakening the electrical switch.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a sectional view illustrating an electrical switch of the prior art;

FIG. 2 is a perspective view of an electrical switch according to an embodiment of the invention;

FIG. 3 and FIG. 4 are exploded views of an electrical switch according to an embodiment of the invention;

FIG. 5A is a sectional view taken along the section 5A-5A of FIG. 2;

FIG. 5B is a sectional view showing the operation of the electrical switch;

FIG. 6 is a perspective view of an electrical switch according to another embodiment of the invention; and

FIG. 7 is a sectional view taken along the section 7-7 of FIG. 6.

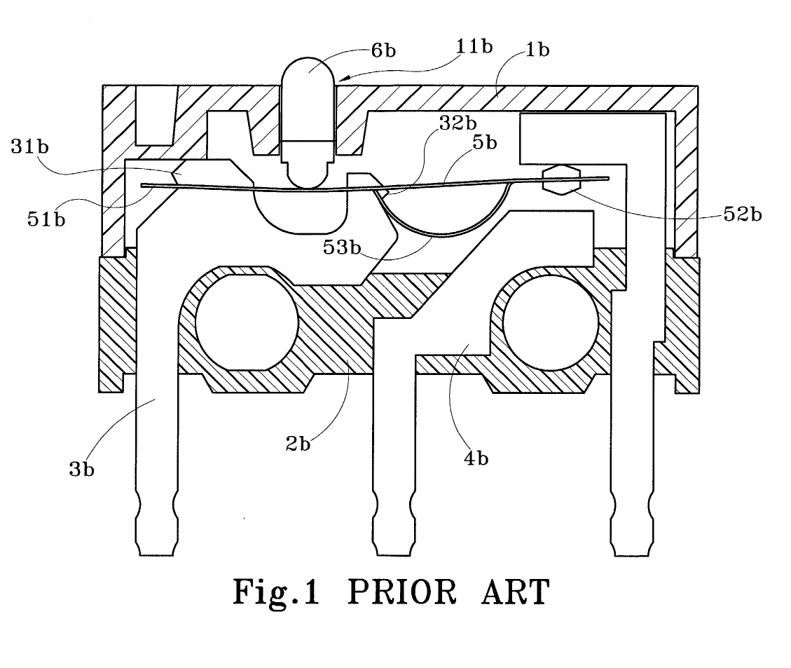

### DETAILED DESCRIPTION OF THE EMBODIMENTS

Wherever possible in the following description, like reference numerals will refer to like elements and parts unless otherwise illustrated.

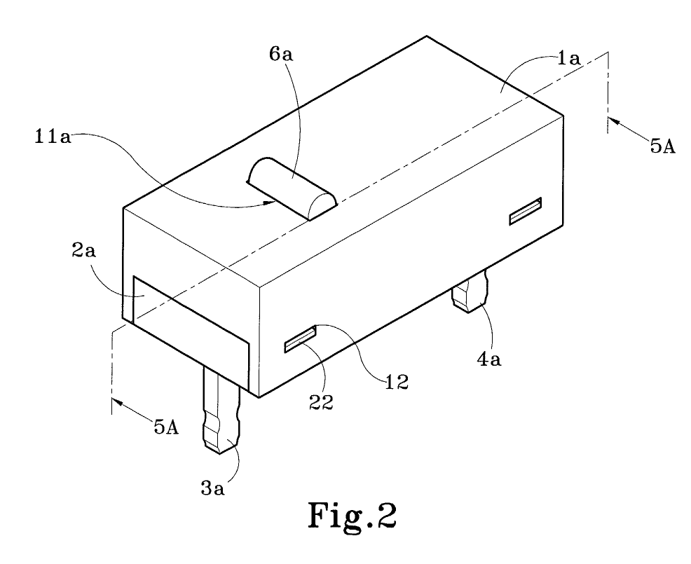

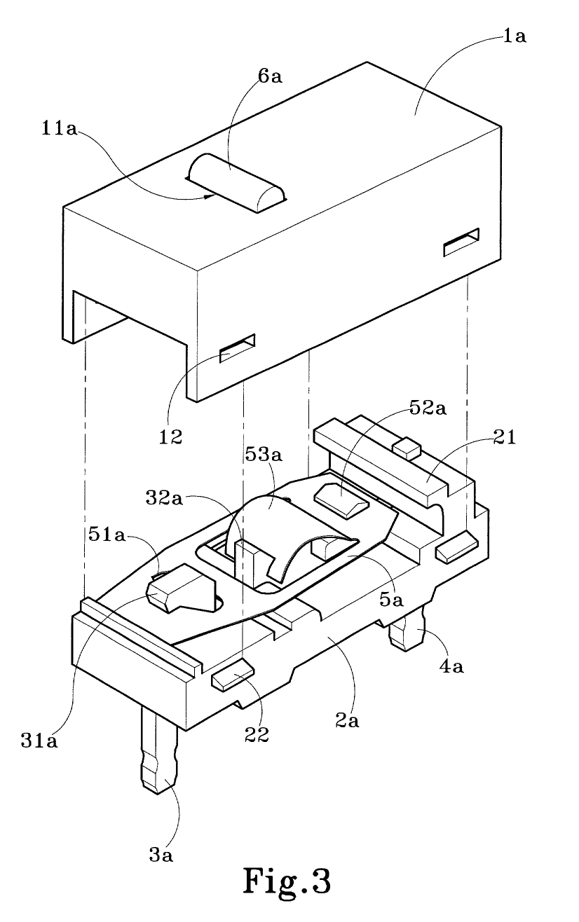

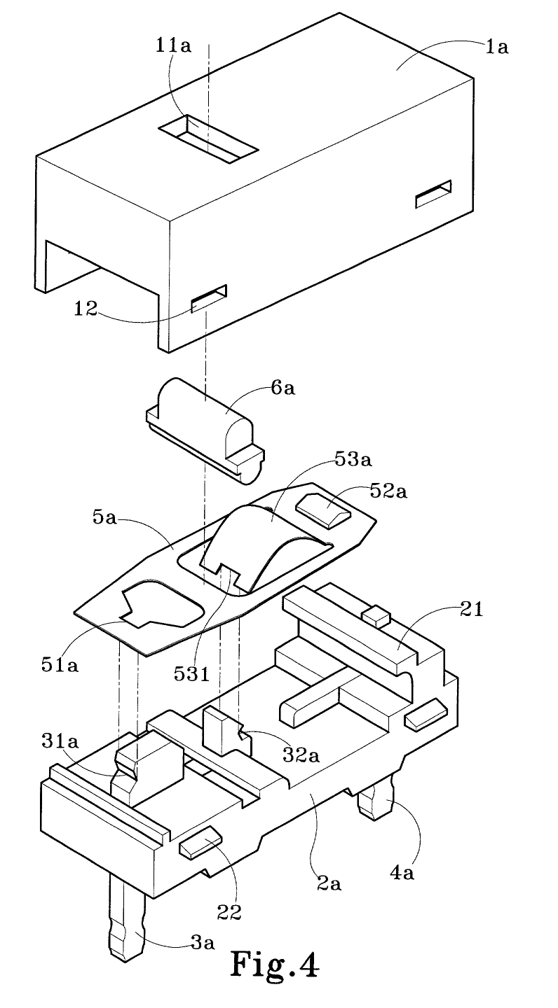

Referring to FIG. 2, FIG. 3, and FIG. 4, various perspective and exploded views illustrate an electrical switch according to an embodiment of the invention. As illustrated, the electrical switch comprises a base 2a and an upper cover 1a that assemble with each other. On sidewalls of the upper cover 1a and base 2a are respectively formed projections 22 and recessed portions 12 that correspondingly engage with one another. The base 2a is integrally formed by injection molding, and includes a reinforcement 21 projecting toward the upper cover 1a. Once the upper cover 1a and the base 2a are fastened to each other via the engagement of the projections 22 and the recessed portions 12, the reinforcement 21 supports and reinforces either the upper cover 1a or the base 2a that may be weakened due to a reduced thickness. First and second insertion legs 3a, 4a are further arranged through the base 2a. First and second positioning portions 31a, 32a, “<” shaped, are integrally formed on the first insertion leg 3a. A hole 11a is further defined through the upper cover 1a, and a conductor resilient plate 5a is mounted over the first and second insertions legs 3a, 4a within the base 2a. The plate 5a is provided with a mounting part 51a that fits the first positioning portion 31a, and a contact pad 52a is placed vis-a-vis the second insertion leg 4a. Integrally formed with the plate 5a, a resilient tongue 53a extends and bends toward the upper cover 1a. A notch 531 is defined at an end of the tongue 53a to be fastened to the second positioning portion 32a. The plate 5a is further provided with a push button 6a that is externally exposed through the hole 11a, enabling a pressing of the plate 5a.

By placing the resilient tongue 53a and the push button 6a on a same upper side of the plate 5a, the push button 6a being placed parallel to the tongue 53a, the height of the electrical switch can be substantially reduced. An electrical switch hence constructed can therefore satisfy the requirements of reduced mount space.

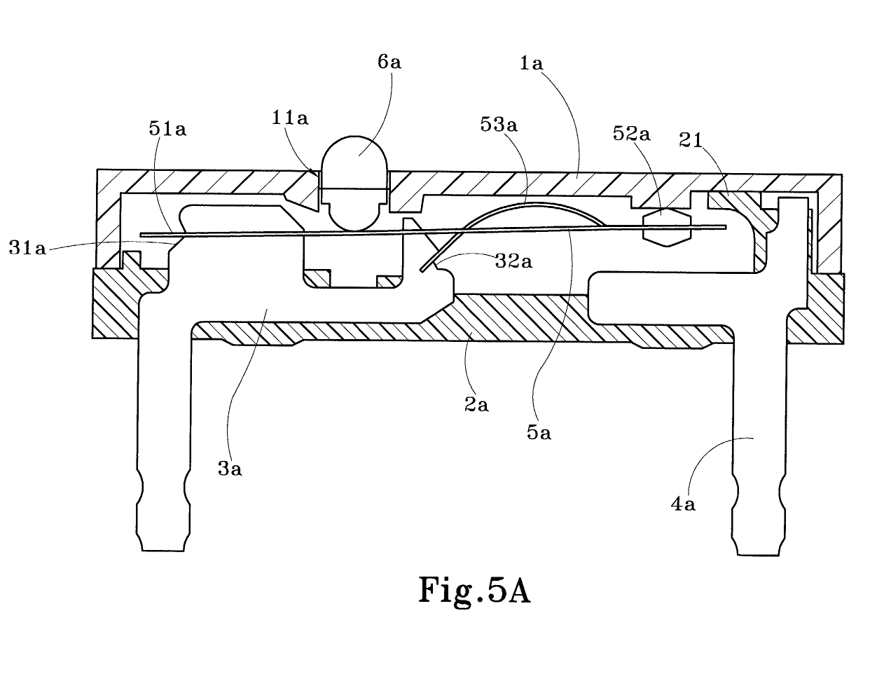

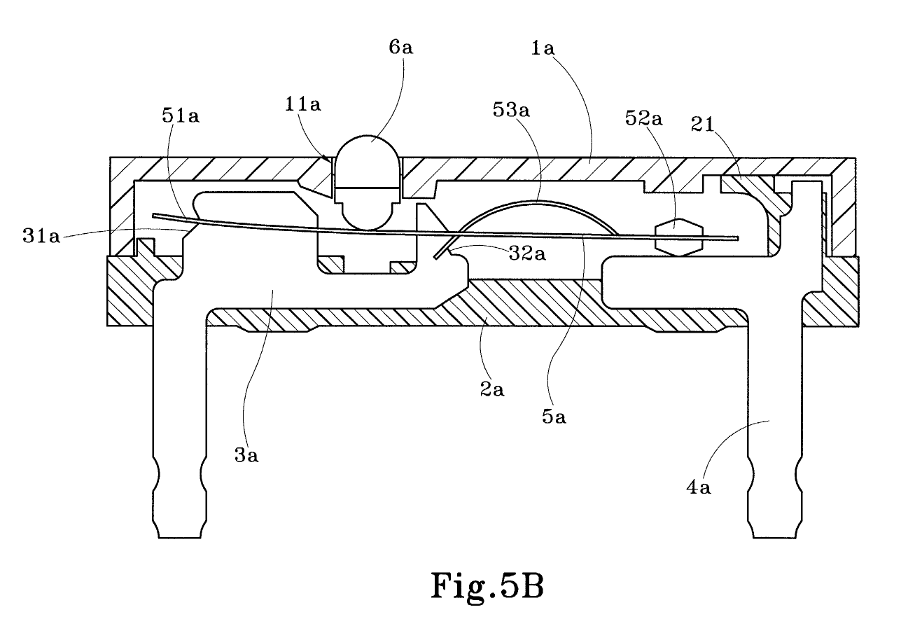

Referring to FIG. 5A and FIG. 5B, two sectional views illustrate the operation of the electrical switch according to an embodiment of the invention. As illustrated, the mounting part 51a and the notch 531 are respectively positioned and mounted to the first and second positioning portions 31a, 32a (in order to accommodate the tongue 53a, the bending direction of the second positioning portion 32a differs from that of the prior art). In order to prevent any separating displacement before the upper cover 1a is mounted, an opposite end of the plate Sa extends below the reinforcement 21 of the base 2a to be thereby restrictedly positioned. Once the upper cover 1a is mounted to the base 2a, the user can turn the switch by pressing the push button 6a. The push button 6a consequently pushes the plate 5a that, via the rotation points respectively formed by the mount of the mounting part 51a to the first positioning portion 31a and the mount of the notch 531 to the second positioning portion 32a, deflects and causes the contact pad 52a to electrically contact with the second insertion leg 4a. The first and second insertion legs 3a, 4a are thereby electrically connected to each other.

As shown in the drawings, since the tongue 53a and the push button 6a are placed on a same side, the height of the switch can be favorably reduced. For reference, the height of the switch of the invention (without considering the insertion legs 3a, 4a) can be optimally 3.6 mm, which is about a half of the conventional switch height of 7.3 mm. The electrical switch of the invention can therefore satisfy the requirements of dimensional reduction. Furthermore, even if the tongue 53a inadvertently separates from the second positioning portion 32a, a consequent upward deviation of the tongue 53a will be restricted by the reinforcement 21, and inadvertent electrical contact with the second insertion leg 4a is thereby prevented. A secure control of the command output can be therefore achieved.

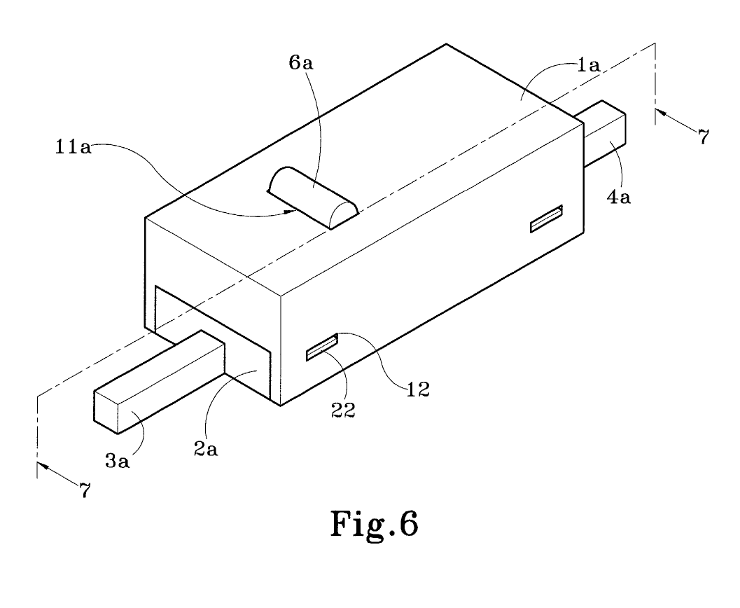

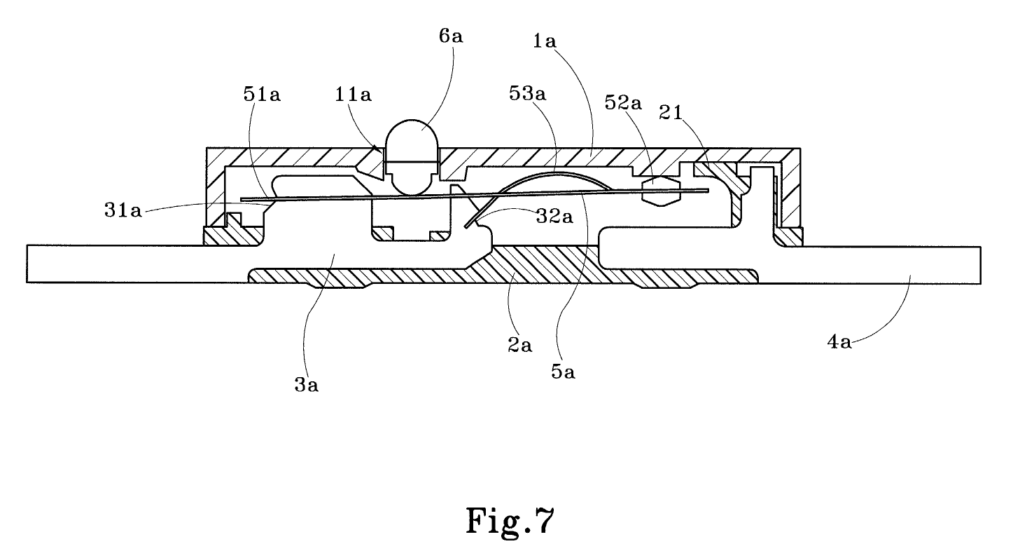

It should be apparent to those skilled in the art that the above description is only illustrative of specific embodiments and examples of the invention. For example, FIG. 6 and FIG. 7 are a perspective view and a sectional view that illustrate another variant embodiment of the invention where the first and second insertion legs 3a, 4a may be fabricated by SMT (surface mount technology).

What is claimed is:

1. An electrical switch comprising:
an assembly of a base and an upper cover, the base including a first and a second insertion leg being arranged there through, a first positioning portion and a second positioning portion being further formed on the first insertion leg, the upper cover further including a hole; and
a conductor resilient plate, including a first portion with a mounting part mounted to the first positioning portion, a second portion having a contact pad placed vis-a-vis the second insertion leg, and a resilient tongue extending and bending toward the upper cover and terminating in a notch mounted to the second positioning portion, wherein a push button is placed over the conductor resilient plate in a manner to be parallel with the resilient tongue on a same side of the conductor resilient plate, thereby reducing the height of the electrical switch.

2. The electrical switch of claim 1, wherein a reinforcement integrally formed with the base by injection molding further extends toward the upper cover.

3. The electrical switch of claim 1, wherein a plurality of projections and a plurality of recessed portions are correspondingly formed on sidewalls of the base and the upper cover.
